(19) United States
(12) Patent Application Publication
(10) Pub. No.: US 2025/0235912 A1
(43) Pub. Date: Jul. 24, 2025

(54) Method for Recovering Reusable Aggregate from Ash from Domestic Waste Incineration Systems

(71) Applicant: H-U-R HAMBURG GMBH HAMBURGER-UMWELT-RECYCLINGTECHNOLOGIEN, Hamburg (DE)

(72) Inventors: Claus GRONHOLZ, Ahausen OT Eversen (DE); Andre GRONHOLZ, Tangstedt (DE)

(21) Appl. No.: 18/703,294

(22) PCT Filed: Oct. 19, 2022
(86) PCT No.: PCT/EP2022/079009

§ 371 Date: Apr. 19, 2024

(30) Foreign Application Priority Data
Oct. 21, 2021 (DE) 10 2021 127 319.6

(51) Int. Cl. B09B 3/70; B09B 3/40; B09B 101/30

(52) U.S. Cl. CPC B09B 3/70; B09B 3/40; B09B 2101/30

(57) ABSTRACT

A method for recovering reusable aggregate from ash from domestic waste incineration systems is provided. Before a predeterminable maximum intermediate storage time has expired after the ash is produced, the ash is subjected to a dynamic carbonation until the remaining moisture content is less than 8.0 wt. % if the ash has a large moisture content, the dynamically carbonized ash or the ash which already has a remaining moisture content of less than 8.0 wt. % is comminuted and classified into multiple grain fractions, at least iron-containing compounds and iron oxides as well as non-iron metals are separated from each grain fraction independently of one another, and at least some of the iron-containing compounds and iron oxides and grain fractions which are free of the non-iron metals are respectively subjected to a main washing process in which the environmentally harmful pollutants adhering to the individual grains are at least partly removed.

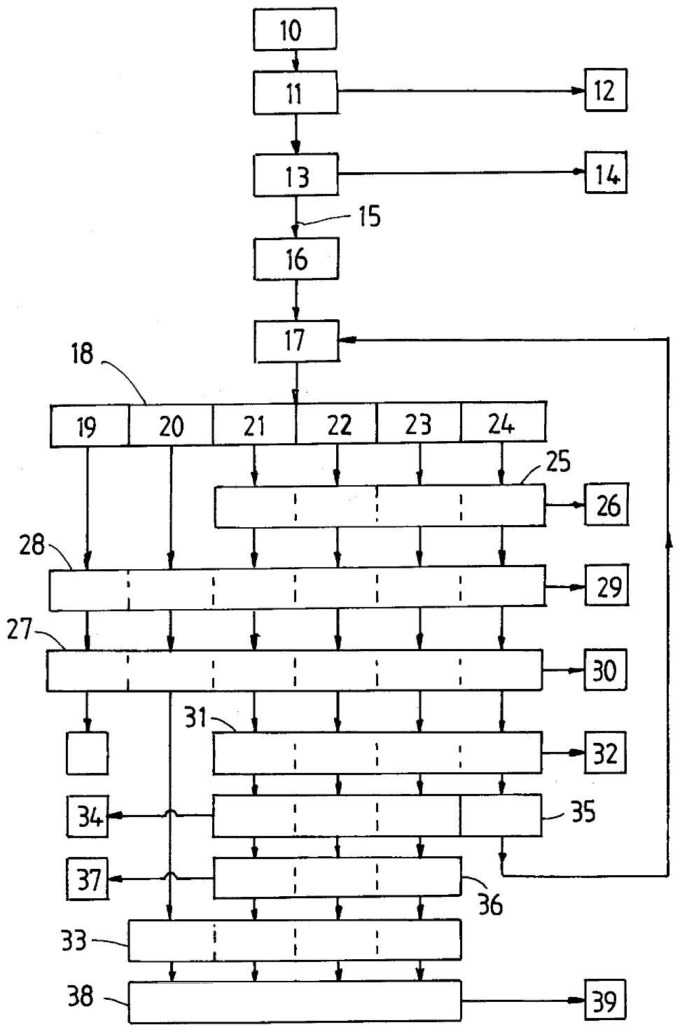

The invention relates to a method for recovering reusable aggregate from ashes from domestic waste incineration plants.

When domestic waste is thermally recycled, large quantities of grate and boiler ash are created as residues, which must be disposed of. These grate/boiler ash or ashes from domestic waste incineration plants (DWIP) or waste incineration plants (WIP) contain not only minerals but also metals, stones and glass, other unburned or non-combustible residues and pollutants that do not allow or make simple landfilling impossible. Any other use of the grate/boiler ash, for example as filler or building material in the construction industry, is not easily or even not possible due to the pollutants it contains and the poor building physics properties.

Nevertheless, it would be desirable to use the processed grate/boiler ash, also referred to here as slag, at least as a filler or additive in the construction industry, since in this way the slag can be traded like a mineral building material. This means that landfilling and the mining of the otherwise required raw materials, such as gravel, natural stone and sand, for such use can be avoided.

In order for granulate to be used as a building material, for example in road construction, it must comply with specified limit values for certain pollutants. These are for Germany e.g. set out in the technical rules of the state waste working group (TR-LAGA Boden). Depending on the pollutant content, the slags are divided into certain classification values Z0, Z1, Z2, Z3 and higher. Slags with a classification value Z0 can be used without restrictions. The classification value Z1 allows it to be used as a building material without any additional technical equipment. When it comes to the classification value of Z1, the TR LAGA Boden distinguishes between the values Z1.1 and Z1.2. With a classification value of Z2, sealing measures must be taken if the processed slag is to be used as an unbound base layer in order to prevent pollutants from being washed out of the slag and thereby contamination of the soil or groundwater. Sulphates, chlorides or water-soluble metal compounds are particularly considered as pollutants.

For the construction industry, slag granules with a classification value of Z1 are therefore of great importance. In addition to the TR-LAGA, DWIP slags are also classified according to the regulations of the TL-Gestein StB (Technische Lieferbedingungen für Gesteinskörnungen im Straßenbau, Technical Delivery Conditions for Aggregates in Road Construction). A distinction is made here between a slag according to HMVA-2 according to TL-Gestein StB and a slag according to HMVA-1 according to TL-Gestein StB, which has to maintain significantly lower pollutant levels. Corresponding regulations apply in other countries.

The subsequently published DE 10 2020 119 699.7 describes a method and a device with which the pollutants described above can well be removed from the DWIP ash. In this method and in this device, the ash is subjected to ultrasound in a water bath by ultrasound generators in order to dissolve the pollutants, such as chlorides, sulfates and water-soluble metal compounds.

In principle, however, it would also be desirable to obtain certified building products from DWIP ash or WIP ash that can be used without further restrictions.

Usually, the fresh ash is initially temporarily stored for several months. During the deposition of the slag, carbonation occurs. In this process, calcium carbonate (CaCO₃) is formed from the calcium oxide (CaO) contained in the slag and carbon dioxide (CO₂) from the air, which is also called carbonate of lime. This process is also known as static carbonation, as the process takes place over a longer period of around twelve weeks, during which the ash is hardly or not moved at all. Through this chemical process the ash solidifies into a hydraulically bound mixture of substances. The ash thus carbonated and solidified is very unstable in terms of building physics and therefore does not meet the building physics parameters for aggregates in concrete.

The most significant exceedances for slag granules made from ash carbonated in this way are in the frost resistance according to DIN EN 1367-1 and the resistance to frost-thaw-salt stress according to DIN EN 1367-6. This means that the slag granules obtained from statically carbonated ashes cannot be used as aggregates in concrete in accordance with DIN EN 12620.

It is an object of the invention to develop a process of the type described above in such a way that a reusable aggregate can be obtained from the ash of domestic waste incineration plants. In particular, the slag processed using the method according to the invention should be usable as certified aggregate for concrete, for example according to DIN EN 12620.

The object is solved according to the invention in that the ash is not deposited as usual for a period of approximately twelve weeks, but is processed as fresh slag within a predeterminable maximum intermediate storage time. For this purpose, the granules are preferably treated in a rotating drum with the addition of heat and CO₂. During this process, CaCO₃ from Cao and CO₂ is formed in a few minutes during the treatment. The carbon dioxide is fed into the drum via the burner. At the same time, the fine ash particles that are on the surfaces of the slag granules are separated by the rotation of the drum and sucked away by a filter system. This dynamic carbonation prevents the formation of mechanically unstable solidified slag granules.

It is therefore provided according to the invention that the ashes are exposed to CO₂ and heat before the expiry of a predeterminable maximum intermediate storage time after their formation. This continues until the ash has a residual moisture content of less than 8.0 wt. % or less than 4.0 wt. %.

Furthermore, the ash thus carbonated is crushed and classified into several grain fractions, and from each grain fraction at least iron-containing compounds and iron oxides as well as the non-ferrous metals are separated independently. Subsequently, at least some of the grain fractions freed from the iron-containing compounds and iron oxides and from the non-ferrous metals are each subjected to a main wash, in which the pollutants adhering to the individual grains and polluting the environment are at least partially removed. The starting material used is fresh ash from domestic waste incineration plants in which natural or static carbonation has not yet taken place or has only occurred to a small extent. The alkaline environment of a building material to be produced with it is thus maintained. This is advantageous for concrete produced with it. Static carbonation, which is unfavorable for use as a building material, is accelerated by a moist environment, which is avoided by early heat treatment within the maximum intermediate storage time. The maximum intermediate storage time can be 96 or 72 or 48 or 24 hours.

The fresh ash can either come from a known wet deslagger or a known dry deslagger. In the first case, the moisture content will usually still be well above 8.0 wt. % after the specified maximum intermediate storage time. Then a dynamic carbonation as described above and the associated drying of the ash is required so that natural or static carbonation cannot occur or can only occur insignificantly. If the ash comes from a dry slag remover, heat treatment is not always necessary required because the moisture content is usually below 8.0 wt. %.

The ash that is dynamically carbonated in this way is then crushed and classified into different grain fractions so that each grain fraction can be subjected to further treatment.

The ash consists mainly of an unstable sintered product from combustion. Impact shredders, for example impact mills or high-speed impact separators, can preferably be used for comminution. This has the advantage that the sintered products of the ash are broken down into stable grains, which are useful and necessary for a building material.

The dynamically carbonated or dry ash can, for example, be classified into six grain fractions: 0/1 mm, ⅓ mm, 3/6 mm, 6/12 mm, 12/22.4 mm and >22.4 mm. The upper grain size 22.4 mm and a resulting granulate mixture with grains between 1 mm and 22.4 mm in size is a granulate fraction for concrete currently commonly used in the construction industry.

It can also be provided that larger components, for example >40 mm or >100 mm, are separated before the dynamic carbonation or comminution of the ash. Such large components in the ash significantly interfere the subsequent processing or classification.

A grain fraction of small grain size, for example <1 mm or <3 mm, can also be separated off before comminution or dynamic carbonation. This has the advantage that the fine portion of the ash that tends to naturally carbonate is separated off in advance. This first rough classification into the fine fraction, the part to be further processed and the large fraction of ash can be carried out easily using simple means.

The further processing and separation of certain components is preferably carried out separately for each of the grain fractions. This means that each cleaning step or each separation step can be adapted and optimized to the respective separation task or cleaning task. This means that the undesirable components are reliably almost completely removed from the respective grain fractions and can be used for other purposes or disposed of.

The further steps required to separate the iron-containing compounds or non-ferrous metals are also made significantly easier by the dry and classified state of the part of the ash to be prepared. The dynamic magnetic fields or neodymium drum magnets that can be used for this work particularly effectively within certain grain boundaries.

The process described in the patent application DE 10 2020 119 699.7 cited at the beginning can be used as the main wash. The ash grains are subjected to ultrasonic in an upright and vertically aligned water channel using an upstream flow process, which can only be carried out effectively for grain fractions with predetermined, relatively narrow grain size ranges, in order to keep the individual grains floating for a relatively long time and freely in the cavitation field, the field of action of the ultrasonic. The flow generated in the water channel against the direction of sinking causes that each individual grain can rotate freely and can therefore be exposed to ultrasonic from all sides. A good cleaning effect is achieved.

Here, it is intended that only the grain fractions between a predeterminable smallest grain size and a predeterminable largest grain size are fed to the main wash, since only these grain fractions can be used sensibly as building material. The smallest grain size can be, for example, 1.0 mm and the largest grain size can be, for example, 22.4 mm. The processed ash would therefore have an aggregate size in accordance with DIN EN 12620.

In order for the ash to be used as a so-called certified building material, it is expedient to separate further components of the ash. It is therefore further provided according to the invention that iron components are removed from the ash before classification. This can be done using known magnetic separators.

It is expedient if the grain fraction below a predeterminable smallest grain boundary is deposited after removal of the iron-containing compounds and iron oxides as well as the non-ferrous metals or is subjected to further processing.

It is also possible to at least partially separate lightweight materials from the grain fractions above a predeterminable first grain boundary. The first grain limit can be 1.0 mm or 3.0 mm, so that the larger lightweight materials are only separated from the grain fractions above this grain size.

Furthermore, it is expedient if VA metals (chromium-nickel steels) are at least partially separated from the grain fractions above a predeterminable first grain boundary. These components above the first grain boundary of, for example, 3.0 mm can be well separated inductively and effectively from individual fractions and used elsewhere.

In addition, glass can be at least partially deposited from the grain fractions above the predeterminable first grain boundary. The processes used for this purpose are also known, and the separated glass can be easily recycled.

Since only grains of a certain maximum size can be used as an aggregate in concrete for a building material, it is also provided that the grain fraction above a predetermined largest grain limit of the ash is returned to the crushing process. This grain fraction is then also crushed to a usable size and goes through the next steps again.

In particular, it is provided that the grain fractions between the smallest and the largest grain size are fed separately to the main wash. The main wash can then be adjusted and optimized to the grain size to be treated. It can be provided that the grain fractions are subjected to a further pre-wash with lightweight material separation before the main wash so that the disturbing lightweight materials are reliably and completely removed.

It is advantageous if the grain fractions are subsequently subjected to a post-wash after the main wash. This allows the components dissolved in the main wash and dissolved components are completely removed. During the main wash with ultrasonic in a water bath with counterflow using the method or device according to the already mentioned DE 10 2020 119 699.7, further lightweight material separation takes place.

The individual grain fractions can be brought together again before or after the final wash. The product is a clean and reusable building material as aggregate e between the predetermined smallest and largest grain sizes of, for example, 1.0 mm and 22.4 mm in accordance with DIN EN 12620 for concrete, which is also largely free of pollutants.

The invention is explained in more detail below with reference to the schematic drawing. The only FIGURE shows the process diagram of the invention.

The ash 10 produced in a domestic waste incineration plant comes either from a wet slag remover or a dry slag remover and therefore differs primarily in its moisture content. In the following description it is assumed that the moisture content of the starting ash is more than 8.0 wt. % or at least more than 4.0 wt. %.

The larger components 12, which are, for example, larger than 40 mm or 100 mm, are separated from the fresh ash 10 within a predeterminable intermediate storage time in a first classification 11 and are deposited or supplied for further use. In a second classification 13, the fine fraction 14 of the ash with a grain size of 0/1 mm or 0/3 mm is separated. This removes from the ash those components 14 that are particularly tend to natural carbonation. These components can be disposed of or subjected to further processing. In these first two classifications 11, 13, the ash can still have a residual moisture content of more than 8.0 wt. %.

The remaining part of the ash 15 is dynamically carbonated in a suitable device 16, in which the fresh ash is exposed to CO₂ and, if necessary, heat during rotation until the ash has a residual moisture content of <8.0 wt. %. This dynamic carbonation preferably takes place in a rotating drum within the predeterminable maximum intermediate storage time of less than 96 or 72 and preferably less than 48 or 24 hours, during which the natural carbonation has not yet started or has only started to an insignificant extent. By treating the fresh ash with CO₂ and heat, its natural carbonation is inhibited. The CO₂ is supplied to the ash through the burner, which heats the heat treatment device 16. If the ash comes from a dry slag remover and already has a residual moisture content of less than 8.0 wt. %, the treatment in the device 16 would be limited to the supply of CO₂.

The ash carbonated in this way is comminuted in a comminution stage 17. Known impact crushers can be used, which break down the ash into its mechanically stable particles but do not grind it. Larger components of usable ingredients are therefore retained. The resulting mixture of ash granules of different grain sizes is classified in a further step 18. It can be provided that the crushed ash, which has a maximum grain size of 40 mm or 100 mm due to the previous classification in steps 11 and 12, is classified into one grain fraction 19 with grains smaller than 1 mm, a grain fraction 20 with grains between 1 mm and 3 mm, a grain fraction 21 with grains between 3 mm and 6 mm in size, a grain fraction 22 with grain sizes between 6 mm and 12 mm, a grain fraction 23 with grains between 12 mm and 22.4 mm and a grain fraction with grains larger than 22.4 mm.

These six fractions are fed independently and separately for further processing. Instead of the six fractions shown, more or fewer fractions as well as other grain sizes can be provided.

Through the classification and subsequent independent processing of the individual grain fractions 19, 20, 21, 22, 23, 24, the corresponding methods and devices can be optimally adjusted to the respective grain size range and achieve good results for the respective grain fraction. This is particularly the case if the cleaning or processing step in question depends on the size and therefore also on the weight of the individual grains.

The lightweight materials 26 can first be separated from the larger grain fractions 21, 22, 23, 24, for example in an air classifier 25.

From all grain fractions 19 to 24, the iron-containing compounds or iron oxide-containing components 29 as well as the non-ferrous metals 30 are separated in a dynamic magnetic field 28 and subsequently in an eddy current separator 27. The VA metals (chromium-nickel steels, chromium-nickel-molybdenum steels) 32 can then be separated from the grain fractions 21 to 24 in an inductive process step 31. The larger grain fractions 21 to 24 are particularly suitable for further processing of these VA metals 32, so that only these need to be fed to process step 31.

The smaller grain fraction 20 with a grain size of ⅓ mm can be fed directly to the main wash 33. The micro-fraction 19 can be disposed of or subjected to further processing. The glass 34 contained in the larger grain fractions 21, 22, 23, 24 with a grain size of >3 mm and <40 mm or 100 mm is removed in a further step 35. This can be done with a granulate of this grain size using known methods. This glass 34 can also be easily recycled.

The larger and largely cleaned fraction 24 with a grain size >22.4 mm is fed back to the crushing device 17, since these grain sizes are unsuitable for a conventional building material with a grain size of 1/22.4 mm. By re-crushing, trapped components can also be exposed and removed in the subsequent processing steps.

From these larger grain fractions 21, 22, 23 which have been cleaned in this way and freed from the above-mentioned components, any lightweight substances 37 still contained therein are removed in a pre-wash 36. The remaining granules are then fed to the main wash 33 in the individual fractions 21, 22, 23. The smaller remaining grain fraction 20 can be fed directly to the main wash 33 after the iron-containing and iron oxide-containing components have been separated off in step 28 and the non-ferrous metals in step 27.

In the main wash 33, the adhering salts and pollutants are, among other things, dissolved from the granules of the respective treated grain fraction 20 to 23 in a water bath subjected to ultrasonic. Because of the relatively narrow grain size ranges of the grain fraction being treated in an upflow reactor, the granules can be kept well within the effective range of the ultrasonic generators in the water bath by means of an appropriately adjusted vertical upward flow. Due to the cavitation in the upflow reactor, mechanically unstable grain fractions are broken up and converted into mechanically stable granules. In this process, any lightweight materials that may still be present can also be washed up and separated.

After the main wash 33, the cleaned and pollutant-free granules can be final cleaned in a post-wash 38. For this purpose, the individual fractions 20, 21, 22, 23 can be brought together again and rinsed, for example, with clear water. The result is a processed granulate 39 in the form of an aggregate between 1 mm and 22.4 mm, as it is prescribed for a building material according to DIN EN 12620 for concrete. The granules have the same or at least comparable properties as an original and non-recycled material.

The advantage of this method shown can also be seen in the fact that ash or its granules of a certain grain fraction are always subjected to the provided treatment. The relevant apparatus and devices, such as eddy current separators, magnetic drums, air classifiers, upflow reactors with ultrasonic generators, can then be adapted and operated according to the size of the granulate to be treated. The dynamic carbonation of the ash, a short time after it is created, creates the conditions for later use of the cleaned granules as a certified building material.

There is also no need to provide a large number of similar devices for treating the different grain fractions. Rather, one device is sufficient whose operating parameters are adapted to the respective grain fraction. The amount of equipment required is thus reduced.

1: A method for obtaining a reusable aggregate from ashes from domestic waste incineration plants, characterized in that ash is subjected to dynamic carbonation with addition of carbon dioxide (CO₂) before expiration of a predeterminable maximum intermediate storage time after its creation until remaining moisture content is less than 8.0 wt. % to prevent static carbonation.

2: A method for obtaining a reusable aggregate from ashes from domestic waste incineration plants, characterized in that ash is subjected to dynamic carbonation before expiry of a predeterminable maximum intermediate storage time after its formation until residual moisture content is less than 8.0 wt. % if the ash has a higher moisture content, that the ash treated with heat or the ash already having the residual moisture content less than 8.0 wt. % is crushed and classified into several grain fractions, that at least iron-containing compounds and iron oxides as well as non-ferrous metals are separated from each grain fraction independently of one another, and that at least a portion of the grain fractions freed from the iron-containing compounds and iron oxides and from the non-ferrous metals are each subjected to a main wash in which the adhering to the individual grains and environmentally harmful pollutants are at least partially removed.

3: The method according to claim 1, characterized in that the maximum intermediate storage time is 96 or 72 or 48 or 24 hours.

4: The method according to claim 2, characterized in that iron components are removed from the ash before classification.

5: The method according to claim 2, characterized in that the grain fraction below a predeterminable smallest grain boundary is deposited or fed to further processing after the removal of the iron-containing compounds and iron oxides and the non-ferrous metals.

6: The method according to claim 2, characterized in that lightweight materials are at least partially separated from the grain fractions above a predeterminable first grain boundary.

7: The method according to claim 2, characterized in that VA metals are at least partially deposited from the grain fractions above a predeterminable first grain boundary.

8: The method according to claim 2, characterized in that glass is at least partially deposited from the grain fractions above a predeterminable first grain boundary.

9: The method according to claim 8, characterized in that the grain fraction of the ash above a predetermined largest grain limit is fed before comminution of the ash or directly to the comminution.

10: The method according to claim 2, characterized in that the grain fractions between a smallest and a largest grain size are fed separately from one another to the main wash.

11: The method according to claim 2, characterized in that the grain fractions are subjected to a post-wash after the main wash.

12: The method according to claim 2, characterized in that the ash is classified before dynamic carbonation in order to separate a grain fraction with largest components of the ash.

13: The method according to claim 2, characterized in that the ash is classified before dynamic carbonation in order to separate a grain fraction with smallest components of the ash.

14: The method according to claim 1, wherein the maximum intermediate storage time is 96 or 72 or 48 or 24 hours.

15: The method according to claim 1, wherein the ash is classified before dynamic carbonation in order to separate a grain fraction with largest components of the ash.

16: The method according to claim 1, wherein the ash is classified before dynamic carbonation in order to separate a grain fraction with smallest components of the ash.
